(19) United States
(12) Patent Application Publication
(10) Pub. No.: US 2008/0001774 A1
(43) Pub. Date: Jan. 3, 2008

(54) Remote control with UPnP support and wireless communication service

(75) Inventors: Yung-Lang Huang, Taipei City (TW); Yu-Cheng Tu, Taipei City (TW); Tsung-Yu Ma, Taipei City (TW)

Correspondence Address: BACON & THOMAS, PLLC, 625 SLATERS LANE, FOURTH FLOOR, ALEXANDRIA, VA, 22314, US

(73) Assignee: ASUSTEK COMPUTER INC., Taipei City (TW)

(21) Appl. No.: 11/812,107

(22) Filed: Jun. 15, 2007

(30) Foreign Application Priority Data
Jun. 20, 2006 (TW) 095121995

(51) Int. Cl. G08C 19/00

(52) U.S. Cl. 340/825.72; 340/3.71; 455/74; 340/825.22; 340/825.24

(57) ABSTRACT

A remote control, which can control a plurality of devices with UPnP support, and establish or receive a network phone call. Also a mobile memory module is provided for accessing the data of network account, financial account, or personal data stored in a mobile memory device to support the functions of phone number listing, wireless network payment service, or accessing or showing of personal data. The functions of network phone service and remote controlling are combined to increase the versatility and convenience of a remote control.

### BACKGROUND OF THE INVENTION

1. Field of the Invention

The present invention relates to remote control and, more particularly, to a remote control with UPnP support and wireless communications service.

2. Description of Related Art

UPnP (Universal Plug and Play) is a set of home networking protocols devised to work particularly under windows environment, and through which the implementation of networks in the home or corporate environments can be simplified without having to directly connect to a computer or undergo configuration, saving the need to endure complex installation steps. For example, apparatuses including home appliances, personal computers, and audio equipments with UPnP support can be connected to one another seamlessly and automatically, and the apparatuses within the network can be discovered and controlled via a remote control.

FIG. 1 is a front-view diagram of a traditional UPnP supported remote control 100. Using key board 104, user selects the device displayed on the screen 103 to go into a control list page, from which the desired command to be carried out by the device is then selected, and a wireless control signal is responsively transmitted via an infrared transmitter to the selected device for executing the command accordingly.

However, though the traditional remote control can be used to remotely control multiple devices, its function is also limited thereto. As home networking becomes more prevalent, ways to integrate different device functions in a home environment becomes an immediate issue that needs to be addressed.

Therefore, there is a need to improve the above-mentioned remote control whose function is traditionally limited solely to remote device controlling.

### SUMMARY OF THE INVENTION

An object of the present invention is to provide a remote control with UPnP and wireless communications service support, integrating the functions of network phone and remote controlling into one remote control, for increasing versatility and convenience.

Another object of the present invention is to provide a remote control with UPnP and wireless communications service support, integrating the functions of wireless network payment service and remote controlling into one remote control, for increasing versatility and convenience.

According to one aspect, the present invention which achieves these objects relates to a remote control with UPnP support. The remote control includes a display module for displaying a user control interface; an audio receiver module, for receiving an audio data; a wireless module, for transmitting said audio data wirelessly; a microcontroller unit, connected to the display module, the audio receiver module, and the wireless module, for transmitting via the wireless module a wireless control signal to control the operation of at least a device when the user control interface is operated on; and a mobile memory module, coupled to the microcontroller unit, for retrieving at least a piece of data stored on a mobile memory access unit disposed within the mobile memory module.

According to another aspect, the present invention which achieves these objects relates to a method of controlling a remote control with UPnP support. The remote control is capable of controlling at least an UPnP supported device and also work as a network phone. The remote control has a mobile memory module, which is capable of providing hold for a mobile memory access unit. The method includes the steps of: receiving an audio data, and transmitting the audio data wirelessly; then, operating a user control interface to transmit a wireless control signal to control the operation of at least a device; and retrieving at least a piece of data stored in the mobile memory access unit disposed in the mobile memory module.

Other objects, advantages, and novel features of the invention will become more apparent from the following detailed description when taken in conjunction with the accompanying drawings.

### BRIEF DESCRIPTION OF THE DRAWINGS

FIG. 1 is a front view of a traditional remote control with UPnP support;

FIG. 2 is a functional block diagram of a remote control according to a preferred embodiment of the invention;

FIG. 3 is a front view of a remote control according to an embodiment of the invention;

FIG. 4 is a schematic diagram of a remote control providing network phone connectivity according to an embodiment of the invention;

FIG. 5 is a schematic diagram of a remote control with wireless network payment service according to an embodiment of the invention; and

FIG. 6 is a flow diagram of a method of controlling a remote control according to an embodiment of the invention.

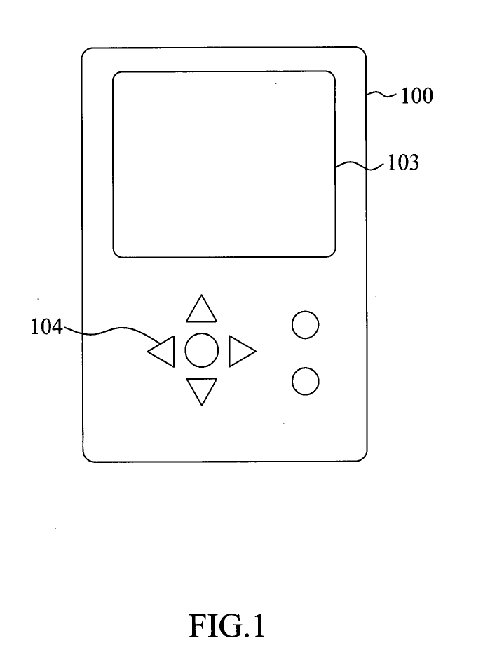

### DETAILED DESCRIPTION OF THE PREFERRED EMBODIMENT

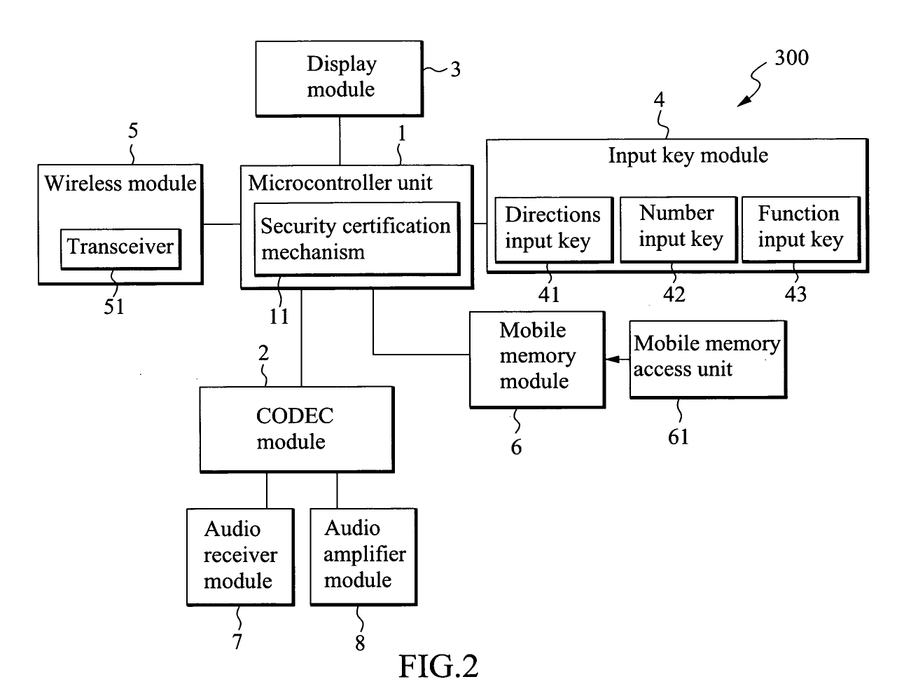

FIG. 2 is a function block diagram illustrating a remote control 300 with UPnP support according to a preferred embodiment of the invention. Remote control 300 includes a MCU (Micro-Controller Unit) 1, a CODEC (Coder/Decoder) module 2, a display module 3, an input key module 4, a wireless module 5, a mobile memory module 6, an audio receiver module 7, and an audio amplifier module 8.

MCU 1 is electrically connected to CODEC module 2, display module 3, input key module 4, wireless module 5, and mobile memory module 6 separately. MCU 1 can support UPnP protocol and network phone protocol, such as SIP (Session Initiation Protocol), to provide operational progress and signal control, enabling the operation of different devices connected to a home network to be controlled, and network calls to be made and/or answered via the network.

The above-mentioned CODEC module 2 is electrically connected to MCU unit 1, audio receiver module 7, and audio amplifier module 8 separately, and performs both coding and decoding. That is, under network phone call, CODEC 2 converts the digital audio data originated from MCU 1 into analog audio data for output to audio amplifier module 8, or converts the audio analog audio data received from audio receiver 7 into digital audio data for output to MCU 1 for further process.

Display module 3 can be an LCD (Liquid Crystal Display) module or any other flat panel display module built in the user control interface of MCU 1 to provide user visual operation assistance. Input key module is a keypad with different inputs operable by the user for controlling the user control interface, and includes at least a directions input key 41 for providing at least up, down, left, and right directional input movements; at least a number input key 42 for providing at least a number input; and, at least a function input key 43 for providing signal input of call connection, call hang-up, confirm, delete, power on/off, and volume adjustment functions.

In another preferred embodiment of the invention, display module 3 is a touch-screen LCD module. The input key module 4 is built in the user control interface of MCU 1 as executable programs. The input keys 41, 41 and 43 are displayed on the touch-screen LCD module 3. Upon the touching of a user's finger or a stylus with the input keys 41, 42, or 43 displayed on the screen of touch-screen LCD module for inputting to the remote control 300, the corresponding input key 41, 42, or 43 is then selected and its commands executed.

In the embodiment, wireless module 5 can receive/transmit wireless signals, e.g. radio frequency or infrared signals, through transceiver device 51 without physically connecting to the network. Namely, wireless module 5 can connect wirelessly to the network, such as a local area network or the Internet, via an access point (not shown). That is, the wireless network communications service is accomplished through the IP phone connection between wireless module 5 and the network; through the communication via VoIP; or through the signal communication with other devices via the network.

Additionally, a mobile memory module 6 is implemented in this embodiment of the invention, and is a communications port that is capable of retrieving at least a piece of data stored within mobile memory access unit 61. For instance, the data is retrieved via an IC (Integrated Circuit) card, or a card reader of a memory card, or a USB port of a USB stick.

In this embodiment, at least said piece of data stored within the mobile memory access unit 61 is a phone number. In other embodiments, the data can be also of a network account, a financial account, or personal data.

Thus, MCU 1 can further include a security certification mechanism for authenticating the phone number, the network account, the financial account, or the personal data stored on the mobile memory access unit.

Audio receiver module 7 is a microphone or a phone handset for receiving and then transmitting audio data to the CODEC module 2 for further processing. Audio amplifier 8 is an earphone, a phone handset, or an audio amplifier, for transmitting the audio data received from CODEC module 2 for user listening.

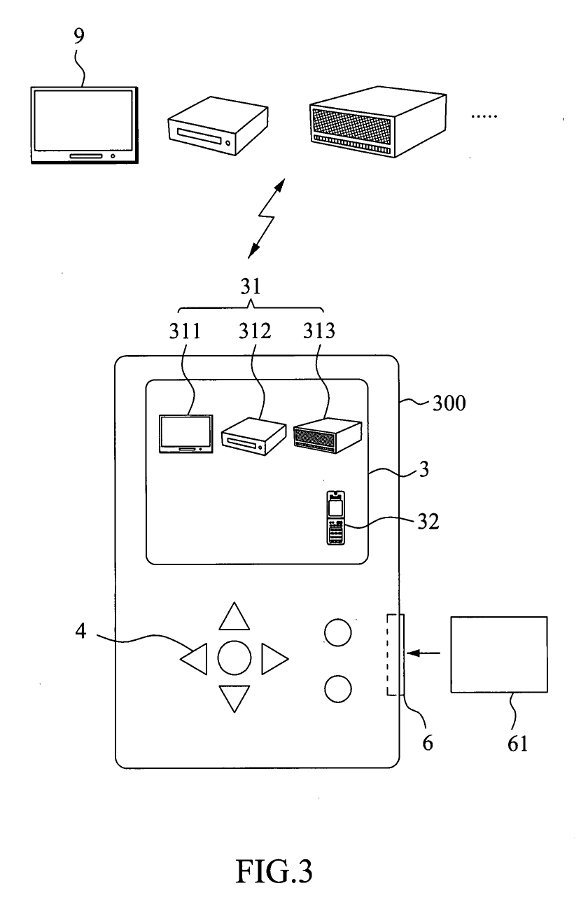

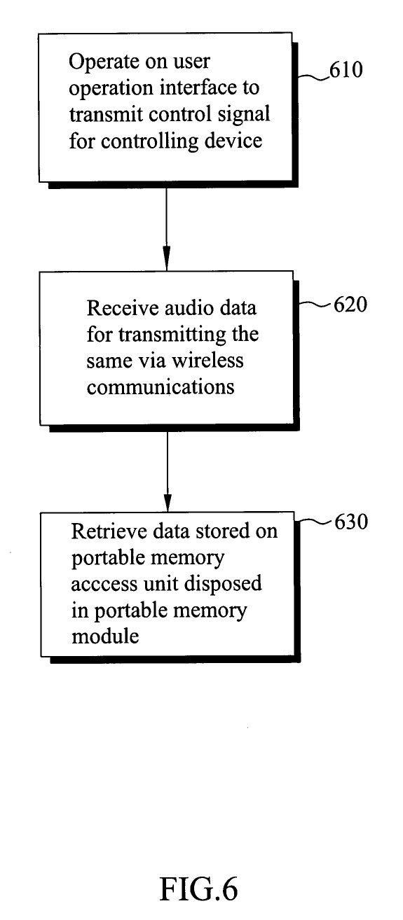

FIGS. 3 and 6 should both be referred to for further illustration of remote control 300 operations. FIG. 3 is a front view of a remote control according to an embodiment of the invention. FIG. 6 is a flow diagram of a method of controlling a remote control according to an embodiment of the invention. First, MCU 1 with UPnP support uses the radio frequency or Infrared signal transceiver device 51 of wireless module 7 to identify one or more devices 9 within the signal reception/transmission range, and after receiving data signals from said device(s) 9, displaying a user operation interface on display module 3 using device icons 31 representative of the identified devices. The device icons 31 can be device names or actual image icons, such as a TV icon 311, a digital AV (Audio/Video) disc player icon 312, and an air conditioner icon 313 etc.

Through such, user can by operating the user control interface transmit wireless control signals via wireless module 5 and control the operation of devices 9 using said wireless control signals (step 610). When user controls the user operation interface using input key module 4 or by selecting device icons 31 via touch-screen, the display module 3 then further displays a next layer of control selection or data list of the device upon the representative device icon 31 being selected. Alternatively, a wireless control signal is transmitted via wireless module 5 to control operation of the corresponding device 9. For instance, after the digital AV disc player icon 312 is selected, then the “play”, “fast forward”, “stop”, “video 1”, “video 2”, “escape” icons can be subsequently displayed on screen. Then, upon pressing of the “play” icon, wireless module 5 transmits a wireless control signal to the digital AV disc player to execute the corresponding command. MCU 1 also displays a network phone icon 32 on display module 3. Remote control 300 is configured as a network phone by selecting the network phone icon 32, such that after the audio data is received from audio receiver module 7, user's voice can be transmitted as audio data through wireless module 5 wirelessly (step 620). That is, to realize the function of a network phone, the remote control is connected to the network via its own wireless module 5. To place a Network call, the phone number is input to the remote control via the input key module 4; the communications information is transmitted via wireless module 5, and audio data is converted and received via the combination of CODEC module 2, audio receiver module 7, and audio amplifier module 8. Through the arrangements as detailed in the embodiment of the invention, both the functions of a remote control and a network phone are incorporated in remote control 300.

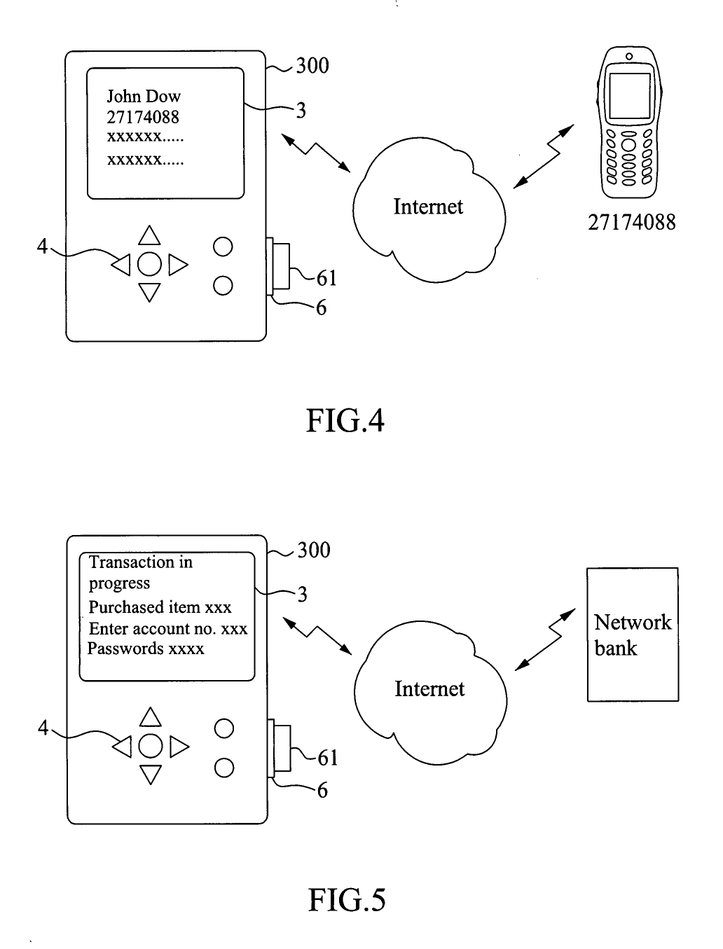

Also, the embodiment of the invention can be configured with a mobile memory module 6 to retrieve information stored in the mobile memory access unit 61 of mobile memory module 6 (step S630). If said stored information is a phone number list, then remote control 300 is configured as a network phone. MCU 1 adds phone numbers to the list stored in the mobile memory access unit 61 through mobile memory module 6, or retrieves the phone number list from mobile memory access unit 61 for displaying on display module 3, as shown in FIG. 4, such that a user can place a call by selecting a phone number therefrom via operating the input key module 4 or via touch-screen method.

If the above-mentioned stored information is network account or financial account, then remote control 300 can further provide wireless network payment service. As shown in FIG. 5, after remote control 300 is configured as a network phone and connects to a network bank or dials to a consuming telephone number through a network source via the wireless module 5, a user proceeds account verification by first retrieving account number and/or password stored on mobile memory access unit 61 via mobile memory module 6 by operating input key module 4 or by touch-screen method. Then, the payment procedure is complete after the serial number of the desired consumer item is input by the user, and/or additional consuming record such as item costs or prepaid credits are transmitted via wireless module 5 to the network bank or to the consuming telephone number.

Alternatively, if the above-mentioned stored information is personal data, then the user can use the remote control 300 to retrieve or playback said personal data.

The above-described method is not limited to the sequential order as prescribed by steps 610, 620, and 630. In other embodiments, the method can be carried out in other sequence of orders.

The embodiment of the invention incorporates both the functionalities of a remote control and a network phone into a multifunctional remote control, giving rise to great convenience and versatility.

Although the present invention has been explained in relation to its preferred embodiment, it is to be understood that many other possible modifications and variations can be made without departing from the spirit and scope of the invention as hereinafter claimed.

What is claimed is:

1. A remote control with UPnP (Universal Plug and Play) support, comprising:
a display module, for displaying a user control interface;
an audio receiver module, for receiving an audio data;
a wireless module, for transmitting the audio data wirelessly;
a microcontroller unit, connected to the display module, the audio receiver module, and the wireless module, transmitting via the wireless module a wireless control signal for controlling the operation of at least a device when the user control interface is being operated on; and
a mobile memory module, coupled to the microcontroller unit, for retrieving at least a piece of data stored on a mobile memory access unit disposed within the mobile memory module.

2. The remote control as claimed in claim 1, wherein the audio receiver module is a phone handset or a microphone.

3. The remote control as claimed in claim 1, further comprising an audio amplifier module, the audio amplifier module being a phone handset, an earphone, a speaker, or an audio amplifier.

4. The remote control as claimed in claim 1, further comprising an input key module for controlling the operation of the user control interface, wherein the input key module comprising a directions key for providing biaxial movements, a number input key for providing number input, and a function input key for providing functional input for a phone conversation.

5. The remote control as claimed in claim 4, wherein the function input key provides input for signaling call hang-up, confirm, delete, power on/off, and volume adjustment functions.

6. The remote control as claimed in claim 1, wherein the display module is an LCD module.

7. The remote control as claimed in claim 6, wherein the LCD module is a touch-screen LCD module.

8. The remote control as claimed in claim 7, wherein the user control interface comprises an input key module, the input key module being displayed on the touch-screen LCD module and touching the input key module displayed on the touch-screen LCD module for inputting to the remote control.

9. The remote control as claimed in claim 1, wherein the microcontroller unit comprises a security certification mechanism for authenticating at least the piece of data stored on the mobile memory access unit.

10. The remote control as claimed in claim 9, wherein at least the piece of data retrieve by the mobile memory module is a phone number, a network account, a financial account, or personal data.

11. The remote control as claimed in claim 1, wherein the mobile memory module is a card reader or a USB (Universal Serial Bus) slot.

12. The remote control as claimed in claim 1, wherein the mobile memory access unit is a smart card, a memory card, or a memory stick.

13. The remote control as claimed in claim 1, wherein an UPnP supported device identified by the microcontroller device is representatively displayed by the display module as a device icon.

14. The remote control as claimed in claim 13, wherein the display module further displays a device icon representative of a network phone, the remote control providing network phone functions by connecting with a network via the wireless module.

15. The remote control as claimed in claim 14, wherein the wireless module connects to a network bank or dials to a consuming telephone number via the network, and transmits both a consuming record, and the account number and password information retrieved from the mobile memory access unit, for providing wireless network payment service.

16. The remote control as claimed in claim 14, wherein the display module displays a list of phone numbers retrieved from the mobile memory access unit, allowing a phone number to be selected from the list to initiate a network call.

17. A method of controlling a remote control with UPnP support, the remote control capable of controlling at least a UPnP supported device and operating as a network phone, the remote control having a mobile memory module, the mobile memory module capable of providing hold for a mobile memory access unit, the method comprising the steps of:
receiving an audio data, and transmitting the audio data wirelessly;
operating a user control interface to transmit a wireless control signal to control the operation of at least a device; and
retrieving at least a piece of data stored in the mobile memory access unit disposed in the mobile memory module.

18. The method as claimed in claim 17, wherein the step of retrieving at least a piece of data is to retrieve a list of phone numbers stored on the mobile memory access unit, allowing a phone number to be selected from said list to initiate a network call.

19. The method as claimed in claim 17, wherein the step of retrieving at least a piece of data is to retrieve account numbers and password information stored on the mobile memory access unit, for providing wireless network payment service.
